(19) United States
(12) Patent Application Publication
(10) Pub. No.: US 2026/0235801 A1
(43) Pub. Date: Aug. 13, 2026

(54) ANTIRESONANT HOLLOW CORE FIBER WITH LOW-INDEX COATING

(71) Applicant: University of Central Florida Research Foundation, Inc., Orlando, FL (US)

(72) Inventors: Rodrigo Amezcua-Correa, Orlando, FL (US); Jose Enrique Antonio-Lopez, Orlando, FL (US); Axel Schülzgen, Orlando, FL (US); Stephanos Yerolatsitis, Orlando, FL (US); Matthew Cooper, Orlando, FL (US); Joseph Wahlen, Orlando, FL (US)

(21) Appl. No.: 19/153,455

(22) PCT Filed: Feb. 5, 2024
(86) PCT No.: PCT/US2024/014444

§ 371 Date: Aug. 4, 2025

Related U.S. Application Data
(60) Provisional application No. 63/443,230, filed on Feb. 3, 2023.

(51) Int. Cl. G02B 6/02

(52) U.S. Cl. CPC G02B 6/02328

(57) ABSTRACT

A hollow core fiber (HCF) may include a solid tubular cladding structure extending in a longitudinal direction along a length of the HCF and one or more antiresonant (AR) structures extending in the longitudinal direction along the length of the HCF and located in an interior region of the cladding structure, where the one or more AR structures form a central hollow region providing a core region for guiding light. The HCF may further include a low-index coating at least partially surrounding the cladding structure, wherein a refractive index of the low-index coating is lower than a refractive index of the cladding structure to provide guiding of leakage light, where the leakage light includes at least light that decouples from the hollow central core.

### CROSS-REFERENCE TO RELATED APPLICATION

The present application is a national phase entry under 35 U.S.C. § 371 of the Patent Cooperation Treaty number PCT/US 24/14444 filed Feb. 5, 2024, which claims the benefit under 35 U.S.C. § 119(e) of U.S. Provisional Application Ser. No. 63/443,230, filed Feb. 3, 2023, both of which are incorporated herein by reference in their entireties.

### TECHNICAL FIELD

The present disclosure relates generally to antiresonant hollow core fibers and, more particularly, to antiresonant hollow core fibers with a low-index coating.

### BACKGROUND

When transmitting or delivering high-power light through a fiber, any loss of light along the fiber or fiber cable (e.g., unguided light) can cause catastrophic damage to the fiber. In particular, light that is not guided in a core region of the fiber will eventually reach an outer cladding of the fiber. At high average powers, absorption of even small fractions of this unguided light can result in heating and damage to the fiber. The amount of light that leaks into the coating is generally dependent on the refractive index difference between the glass and coating layer and can be further impacted by material stresses such as bending of the fiber, which can create areas of localized absorption known as “hot spots”. There is therefore a need to develop systems and methods to cure the above deficiencies.

### SUMMARY

In embodiments, the techniques described herein relate to a hollow core fiber (HCF) including a cladding structure extending in a longitudinal direction along a length of the HCF; one or more antiresonant (AR) structures extending in the longitudinal direction along the length of the HCF and located in an interior region of the cladding structure, where the one or more AR structures form a hollow central core for guiding light; and a low-index coating at least partially surrounding the cladding structure, where a refractive index of the low-index coating is lower than a refractive index of the cladding structure, where the refractive index the low-index coating is configured to provide guiding of leakage light, where the leakage light includes that decouples from the hollow central core.

In embodiments, the techniques described herein relate to a hollow core fiber, where a thickness of the low-index coating is further configured to provide guiding of the leakage light.

In embodiments, the techniques described herein relate to a hollow core fiber, where the thickness of the low-index coating is in a range of 5 micrometers to 100 micrometers.

In embodiments, the techniques described herein relate to a hollow core fiber, where the hollow core fiber includes one or more cladding light guiding sections extending in the longitudinal direction and one or more cladding light stripping sections extending in the longitudinal direction, where the low-index coating in the one or more cladding light guiding sections has a first thickness, where the low-index coating in the one or more cladding light stripping sections has a second thickness smaller than the first thickness.

In embodiments, the techniques described herein relate to a hollow core fiber, where at least one of the first thickness or lengths of the one or more cladding light stripping sections is selected to couple at least a portion of the leakage light out of the HCF.

In embodiments, the techniques described herein relate to a hollow core fiber, where an outer surface of the cladding structure in the one or more cladding light stripping sections is roughened relative to an outer surface of the cladding structure in the one or more cladding light guiding sections.

In embodiments, the techniques described herein relate to a hollow core fiber, where the refractive index of the low-index coating is in a range of 1.25 to 1.44.

In embodiments, the techniques described herein relate to a hollow core fiber, where the low-index coating has a tensile modulus at 25° C. in a range of 40 MPa to 2000 MPa.

In embodiments, the techniques described herein relate to a hollow core fiber, further including a high-modulus coating surrounding the low-index coating, where a tensile modulus of the high-modulus coating is higher than a tensile modulus of the low-index coating.

In embodiments, the techniques described herein relate to a hollow core fiber, where a refractive index of the high-modulus coating is higher than the refractive index of the low-index coating.

In embodiments, the techniques described herein relate to a hollow core fiber, where the leakage light further includes light coupled into the hollow core fiber that is not guided in the hollow central core.

In embodiments, the techniques described herein relate to a hollow core fiber, where the cladding structure has a tubular shape.

In embodiments, the techniques described herein relate to an optical cable including a hollow core fiber (HCF) including a cladding structure extending in a longitudinal direction along a length of the HCF; one or more antiresonant (AR) structures extending in the longitudinal direction along the length of the HCF and located in an interior region of the cladding structure, where the one or more AR structures form a hollow central core for guiding light; and a low-index coating at least partially surrounding the cladding structure, where a refractive index of the low-index coating is lower than a refractive index of the cladding structure, where at least one of the refractive index or a thickness of the low-index coating is configured to provide guiding of leakage light, where the leakage light includes that decouples from the hollow central core; where the HCF includes one or more cladding light guiding sections extending longitudinally along the HCF and one or more cladding light stripping sections extending in the longitudinal direction along the length of the HCF, where the low-index coating in the one or more cladding light guiding sections has a first thickness, where the low-index coating in the one or more cladding light stripping sections has a second thickness smaller than the first thickness; and one or more beam dumps in at least some of the one or more cladding light stripping sections to at least one of absorb the leakage light or direct the leakage light out of the optical cable.

In embodiments, the techniques described herein relate to an optical cable, where at least one of the one or more beam dumps includes a heat sink.

In embodiments, the techniques described herein relate to an optical fiber including one or more hollow core sections, each of the one or more hollow core sections formed as a hollow core fiber (HCF) including a cladding structure extending in a longitudinal direction along a length of the HCF; and one or more antiresonant (AR) structures extending in the longitudinal direction along the length of the HCF and located in an interior region of the cladding structure, where the one or more AR structures form a hollow central core for guiding light; one or more solid core sections, each of the one or more solid core sections formed as a solid core fiber including a solid core extending in the longitudinal direction; and a solid cladding section surrounding the solid core; and a low-index coating at least partially surrounding the one or more hollow core sections and the one or more solid core sections, where a refractive index of the low-index coating is lower than a refractive index of the cladding structure of each of the one or more hollow core sections and the solid core of each of the solid core sections.

In embodiments, the techniques described herein relate to an optical fiber, where the one or more hollow core sections have a selected fiber run length, where the one or more solid core sections have lengths shorter than the selected fiber run length.

In embodiments, the techniques described herein relate to an optical fiber, where the one or more solid core sections provide splice points for the optical fiber.

In embodiments, the techniques described herein relate to an optical fiber, where at least one of the one or more solid core sections includes an active fiber, where the solid core of the active fiber includes an optical gain medium.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a simplified cross-sectional view of an HCF with a low-index coating, in accordance with one or more embodiments of the present disclosure.

FIG. 1B is a simplified cross-sectional view of an HCF with a low-index coating operating as a low-modulus coating that is surrounded by a high-modulus coating, in accordance with one or more embodiments of the present disclosure.

FIG. 1C is a simplified cross-sectional view of an HCF with a low-index coating, where the HCF includes multiple sets of antiresonant (AR) structures having different characteristics, in accordance with one or more embodiments of the present disclosure.

FIG. 2 is a simplified side view of an HCF including multiple cladding light guiding sections and cladding light stripping sections.

FIG. 3 is a conceptual side view of an optical cable 300 including at least one HCF 100 with a low-index coating, in accordance with one or more embodiments of the present disclosure.

FIG. 4 is a simplified side view of a hybrid optical fiber including hollow core sections and solid core sections, in accordance with one or more embodiments of the present disclosure.

FIG. 5 is a simplified side view of an optical system providing high power delivery of laser light, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods utilizing a hollow core fiber (HCF) with a low-index coating. Any type of HCF is within the spirit and scope of the present disclosure. For example, some embodiments of the present disclosure are directed to an antiresonant HCF (AR-HCF) with a low index coating, where an AR-HCF includes thin-walled structures within a hollow central region that produce guiding of light through optical antiresonance.

As used herein, the term low-index coating refers to a fiber coating having a refractive index (e.g., an index of refraction) that is lower than a material onto which it is deposited. For example, an HCF as disclosed herein may have a core including one or more hollow cavities, a cladding, and a low index coating surrounding the cladding structures. The low-index coating may then be surrounded by any number of additional materials such as, but not limited to, outer coatings.

It is contemplated herein that light within an HCF that is not guided in the core may propagate through a cladding of the HCF and potentially to additional outer coatings. Such light is referred to herein as leakage light and may result from various sources. For example, leakage light may be associated with light that is not coupled into the core of the HCF (e.g., in cases where there is a mismatch between a spot size of incident light a size of the core), light scattered from the core due to scattering sites, or light that leaks (e.g., decouples) from the core due to bending the fiber.

As an illustration, optical fibers are often offered with a dual coating arrangement to provide optimal protection against forces acting on the fibers when cabled and installed. For example, a soft low-modulus (e.g., low tensile modulus or low Young's modulus) inner primary coating may limit the sensitivity to microbending and/or macrobending by distributing local stresses acting on the fiber. As another example, a hard high-modulus (e.g., a high tensile modulus) outer secondary coating may provide mechanical resistance and protect the fiber from damage. In many typical applications, both of these coatings have a larger index of refraction than an outer cladding of the optical fiber structure. Further, such coatings may absorb leakage light and provide a potential point of damage or may transmit leakage light to additional components around the fiber that may become additional points of damage. Further, leakage light may be particularly problematic in high-power laser applications, where even small fractions of the total input power to the fiber may cause catastrophic damage due to absorption and heating in these outer coatings.

It is further contemplated herein that a low-index coating surrounding the cladding may induce the guiding of leakage light in the cladding structure of the HCF (e.g., as cladding-guided light). As a result, the energy of this leakage light may be confined to the cladding region such that absorption of such light in the low-index cladding or any surrounding materials is negligible, even in high-power applications.

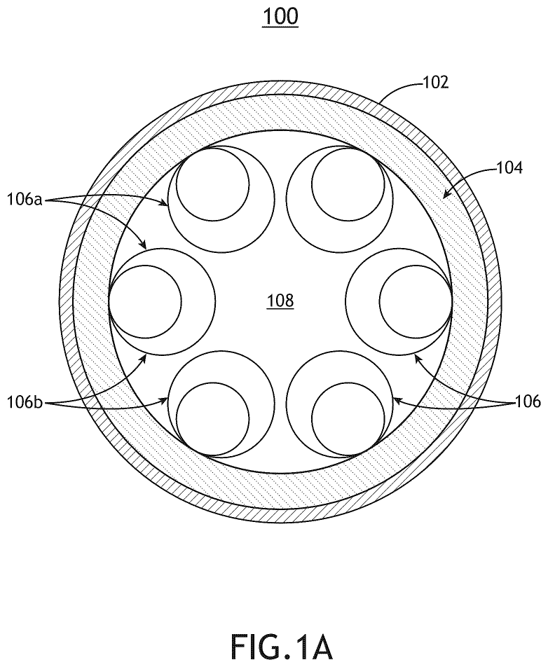

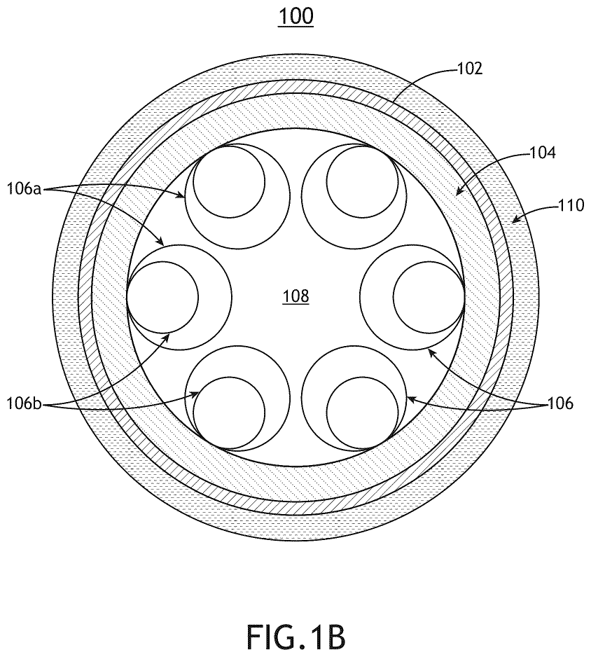

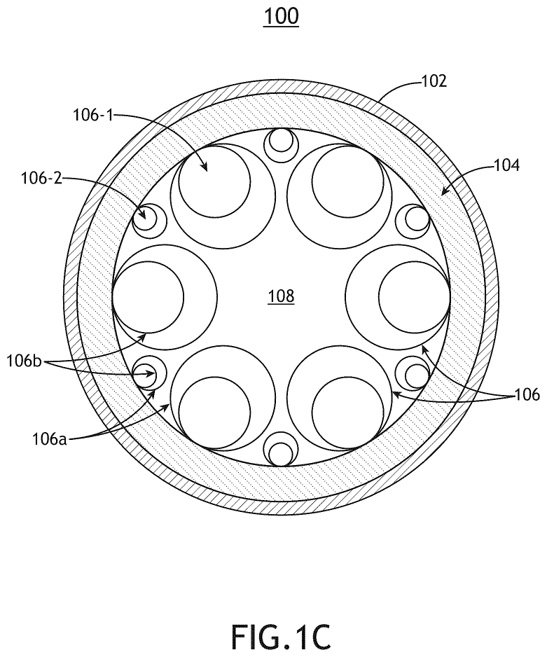

Referring now to FIGS. 1A-4, systems and methods incorporating a low-index coating on an HCF are described in greater detail, in accordance with one or more embodiments of the present disclosure.

As an illustration, FIG. 1A is a simplified cross-sectional view of an HCF 100 with a low-index coating 102, in accordance with one or more embodiments of the present disclosure. The HCF 100 of FIG. 1A includes a solid cladding structure 104 with a tubular shape and various antiresonant (AR) 106 within an interior of the cladding structure 104 to provide guiding in a hollow (e.g., gas-filled) central core 108, where the AR structures 106 are formed as thin-walled extending longitudinally along a length of the HCF 100 and arranged around an inner perimeter of the cladding structure 104 designed to guide light primarily within the hollow central core 108 through optical antiresonance. It is recognized, however, that the distribution of light within the HCF 100 may extend beyond the hollow central core in some cases and that the distribution of light may be impacted by the specific design of the AR structures 106 as well as bending of the HCF 100.

More particularly, the AR structures 106 in the HCF 100 of FIG. 1A include a series of first AR structures 106a formed as thin-walled AR elements extending attached to the perimeter of the cladding structure 104 and a set of second AR structures 106b nested within the first AR structures 106a. Each set of first AR structures 106a and nested second AR structures 106b may be referred to as a nested set of AR structures 106.

In general, the cladding structure 104 and the AR structures 106 may be formed from any material suitable for guiding light in the hollow central core 108. For example, the cladding structure 104 and/or the AR structures 106 may be formed from fused silica (e.g., doped or undoped), germanate glass, telluride glass, chalcogenide glass, or the like.

The low-index coating 102 may be formed from any material having a lower refractive index than at least the cladding structure 104 and a thickness suitable for confining leakage light in the cladding structure 104. For example, the low-index coating 102 may have, but is not required to have, a refractive index in a range of 1.25 and 1.44. Further, the low-index coating 102 may have, but is not required to have a thickness in a range of 5 and 2000 micrometers (μm). In some cases, the low-index coating 102 has a thickness in a range of 10 and 30 μm . In some cases, the low-index coating 102 has a thickness in a range of 5 and 100 μm . For example, the low-index coating 102 may be formed as an ultraviolet-light (UV) curable fluoro-acrylate polymer, fluoro-urethane, fluoro-siloxane, or other similar fluoride-doped materials, but this is not a requirement.

Further, various aspects of the cladding structure 104 such as, but not limited to, the thickness, may be designed to promote guiding of leakage light. In this way, various aspects of the HCF 100 may be designed to enable the delivery of high-power laser light and simultaneously mitigate the impact of leakage light. In this way, leakage light that is not guided within the hollow central core 108 for any reason may be guided in the cladding structure 104, which may reduce absorption of the leakage light by materials outside the cladding structure 104.

The low-index coating 102 may further have any suitable mechanical properties. In some embodiments, the low-index coating 102 has, but is not required to have, a strip force in a range of 0.4 and 7 N, which may facilitate stripping in select regions as is described in greater detail below. Further, the low-index coating 102 may be designed to operate at relatively low or relatively high temperatures. For example, in laser beam delivery, the low-index coating 102 may generally need to be resistant to relatively high temperatures to withstand the high powers propagating through the HCF 100.

The HCF 100 may further include any number or combination of materials outside the low-index coating 102 such as, but not limited to, one or more coatings, sheaths, or mechanical supports.

For example, the HCF 100 may include multiple coatings with different tensile moduli designed to provide resilience against external forces (e.g., when the HCF 100 is deployed in an application environment, combined with other fibers in a cable, or the like). As an illustration, the HCF 100 may include a soft-modulus coating with a relatively low tensile modulus to limit sensitivity to and/or macrobending by distributing local stresses acting on the fiber covered by a high-modulus coating with a relatively high tensile modulus to provide mechanical resistance and protection.

In some embodiments, the low-index coating 102 further operates as a soft low-modulus (e.g., low tensile modulus) coating, which may distribute local stresses acting on the fiber when bent. For example, the low-index coating 102 may have, but is not required to have, a tensile modulus (e.g., at 25° C.) between 40 and 2000 MPa.

In some embodiments, the HCF 100 may further include a high-modulus (e.g., a high tensile modulus) coating surrounding the low-index coating 102, which may have a higher refractive index than the low-index coating 102. Additionally, the high-modulus coating may have a higher refractive index than the low-index coating 102.

FIG. 1B is a simplified cross-sectional view of an HCF 100 with a low-index coating 102 operating as a low-modulus coating that is surrounded by a high-modulus coating 110, in accordance with one or more embodiments of the present disclosure.

The high-modulus coating 110 may be formed from any material having a higher tensile modulus than the low-index coating 102. For example, the high-modulus coating 110 may have, but is not required to have, a tensile modulus (e.g., at 25° C.) above 2000 MPa. As an illustration, a high-modulus coating 110 formed from fluoro-siloxane may have a tensile modulus in a range of 1-300 MPa. As another illustration, a high-modulus coating 110 formed from fluoro-urethane may have a tensile modulus in a range of 1-700 MPa. However, these are merely examples and should not be interpreted as limiting the scope of the present disclosure.

The high-modulus coating 110 may further have a higher refractive index than the low-index coating 102. In this way, the high-modulus coating 110 may be a high-index coating. For example, in an embodiment where the low-index coating 102 has a refractive index of 1.33 at the wavelength of operation, the high-modulus coating 110 may have a refractive index of 1.4 or greater.

Further, the high-modulus coating 110 may have any thickness. For example, the high-modulus coating 110 may have a thickness up to 2 mm.

In some embodiments, the HCF 100 includes both a low-modulus coating and a high-modulus coating surrounding the low-index coating 102.

It is to be understood that the specific design of the cladding structure 104 and the AR structures 106 in FIGS. 1A-1B is provided solely for illustrative purposes and should not be interpreted as limiting. Rather, the core and cladding regions of the HCF 100 may generally have any design suitable for guiding light within the hollow central core 108. For example, an HCF 100 may include any number of AR structures 106 (or nested sets of AR structures 106) distributed around the inner perimeter of the cladding structure 104 such as, but not limited to, 2, 3, 4, 5, 6, 7, 8, or more AR structures 106 (or nested sets of AR structures).

As another example, an HCF 100 may include multiple sets of AR structures 106 having different sizes and/or numbers of nested AR structures 106. FIG. 1C is a simplified cross-sectional view of an HCF 100 with a low-index coating 102, where the HCF 100 includes multiple sets of AR structures 106 having different characteristics, in accordance with one or more embodiments of the present disclosure. In particular, FIG. 1C depicts a design of an HCF 100 including a first set of AR structures 106-1 having first dimensions and a second set of AR structures 106-2 having second dimensions. In this configuration, both of the first set of AR structures 106-1 and the second set of AR structures 106-2 include nested sets of first AR structures 106a and second AR structures 106b, but where the outer sizes first AR structures 106a are larger than for the second AR structures 106b. It is contemplated herein that the HCF 100 depicted in FIG. 1C may have relatively low losses even when the HCF 100 is bent (e.g., may have relatively low microbending and/or macrobending losses).

More generally, any design of an HCF 100 may include a low-index coating 102 as disclosed herein to promote the guiding of leakage light within the cladding structure 104 to prevent catastrophic damage. For example, a low-index coating 102 may be applied to any of the designs of an HCF 100 provided in U.S. Provisional Patent Application 63/465,716 filed on May 11, 2023, U.S. Provisional Patent Application 63/465,762 filed on May 11, 2023, and U.S. Provisional Patent Application 63/470,560 filed on Jun. 2, 2023; Md. Selim Habib, et al., “Single-mode, low loss hollow-core anti-resonant fiber designs,” Opt. Express 27, 3824-3836 (2019); Matthew Cooper, et al., “600 W Single Mode CW Beam Delivery via Anti-Resonant Hollow Core Fiber,” J. Directed Energy 7, 222 (2022); Matthew A. Cooper, et al., “2.2 KW Single-Mode Narrow-Linewidth Laser Delivery Through a Hollow-Core Fiber,” Optica 10, 1253 (2023); and Matthew Cooper, et al., “KW single mode CW laser transmission in an anti-resonant hollow-core fiber”, Proc. SPIE PC12092, Laser Technology for Defense and Security XVII, PC 120920C (30 May 2022); all of which are incorporated herein by reference in their entireties.

In some embodiments, an HCF 100 further includes one or more sections in which the low-index coating 102 is either partially stripped or fully removed. Such locations are referred to herein as cladding light stripping sections and may be used to controllably remove any leakage light that is guided in the cladding structure of the HCF 100. For the purposes of description, such an HCF 100 may be characterized as having one or more cladding light guiding sections as well as one or more cladding light stripping sections. In this configuration, leakage light may be guided within the cladding structure 104 of an HCF 100 in one or more cladding light guiding regions and controllably decoupled in one or more cladding light stripping sections.

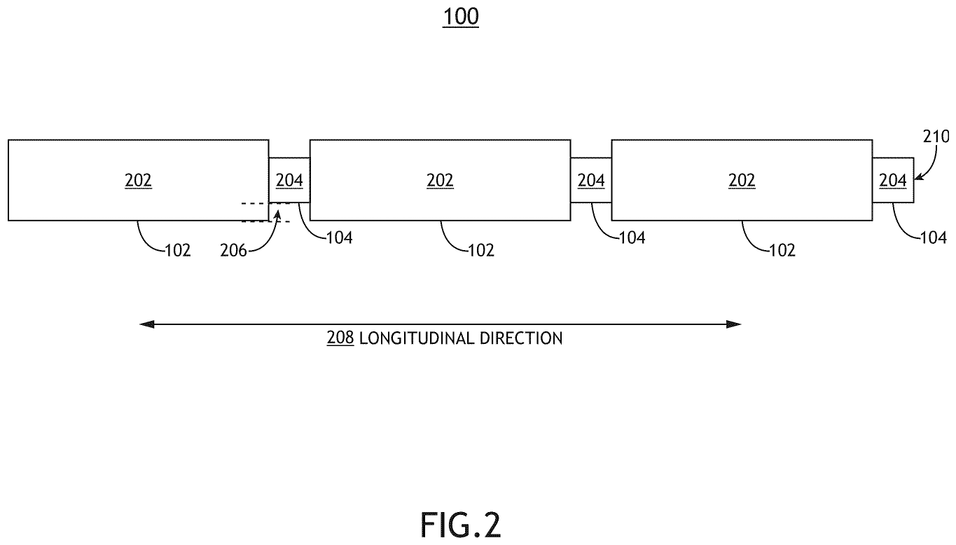

Referring now to FIGS. 2-4, controlled decoupling of light guided within the cladding structure 104 (e.g., leakage light) is described in greater detail, in accordance with one or more embodiments of the present disclosure. In some embodiments, an HCF 100 includes various structures to controllably decouple light guided within the cladding structure 104 without damaging the HCF 100.

FIG. 2 is a simplified side view of an HCF 100 including multiple cladding light guiding sections 202 and cladding light stripping sections 204. In particular, FIG. 2 illustrates a non-limiting configuration of an HCF 100 with three cladding light guiding sections 202 and three cladding light stripping sections 204.

As an illustration, a thickness of the low-index coating 102 in the cladding light stripping sections 204 may be smaller than a thickness of the low-index coating 102 in the cladding light guiding sections 202. In some cases, as illustrated in FIG. 2, the thickness of the low-index coating 102 in the cladding light stripping sections 204 is zero, indicating that the low-index coating 102 has been completely removed (or not deposited) in these sections. This reduced thickness of the low-index coating 102 in a cladding light stripping section 204 may reduce or eliminate the ability to guide light in the cladding structure 104 in this region such that the leakage light may be decoupled from the HCF 100. An outer surface of the cladding structure 104 in a cladding light stripping section 204 may also be roughened to further promote decoupling of the leaking light in this region. For example, the cladding structure 104 may be roughened using any suitable technique including, but not limited to, etching, scratching, engraving, or the like. This rough surface may then scatter leakage light in cladding modes with a high loss rate.

The low-index coating 102 may have any thickness profile or transition within or between any of the cladding light stripping sections 204 or cladding light guiding sections 202. For example, FIG. 2 depicts a step-wise transition of the low-index coating 102 between the cladding light guiding sections 202 (e.g., in which the low-index coating 102 has a selected thickness 206) and the cladding light stripping sections 204 (e.g., in which the low-index coating 102 is at least partially removed). In other examples, though not shown, a thickness of the low-index coating 102 may gradually transition within or between a cladding light guiding section 202 and a cladding light stripping section 204.

Further, a cladding light stripping section 204 may have any length along a longitudinal direction 208 of the HCF 100 suitable for decoupling at least some leakage light from the HCF 100. For example, a cladding light stripping section 204 may have, but is not required to have, a length of a few centimeters to provide a desired amount of decoupling of the leakage light.

An HCF 100 may generally include any number of cladding light guiding sections 202 and/or cladding light stripping sections 204 in any arrangement. In some embodiments, as shown in FIG. 2, an HCF 100 may include a cladding light stripping section 204 at or near an output face 210 of the HCF 100. In this way, any leakage light present in the cladding structure 104 may be removed prior to the output face 210 to avoid retroreflections at the output face 210 or coupling of this leakage out of the output face 210. In some embodiments, as also shown in FIG. 2, an HCF 100 may include one or more cladding light stripping sections 204 distributed along a length of the HCF 100 (e.g., in a longitudinal direction of the fiber). In this way, leakage light may be decoupled out of the HCF 100 at locations prior to the output face 210. These cladding light stripping sections 204 may be periodically distributed or located at sensitive locations (e.g., after bends in the fiber, or the like).

It is contemplated herein that low-index coatings have been demonstrated for some solid-core fiber designs to support guiding of light in a solid cladding region. In the case of an active fiber (e.g., an active solid core fiber), the low-index coating supports guiding of pump light as a mechanism for coupling the pump light into an active solid core and thus “pump” the active core. In the case of a passive solid-core delivery fiber, the low-index coating may support the guiding of light that is not guided within the core. However, it is contemplated herein that an HCF 100 designed for high-power laser delivery with a low-index coating 102 as disclosed herein has not been demonstrated.

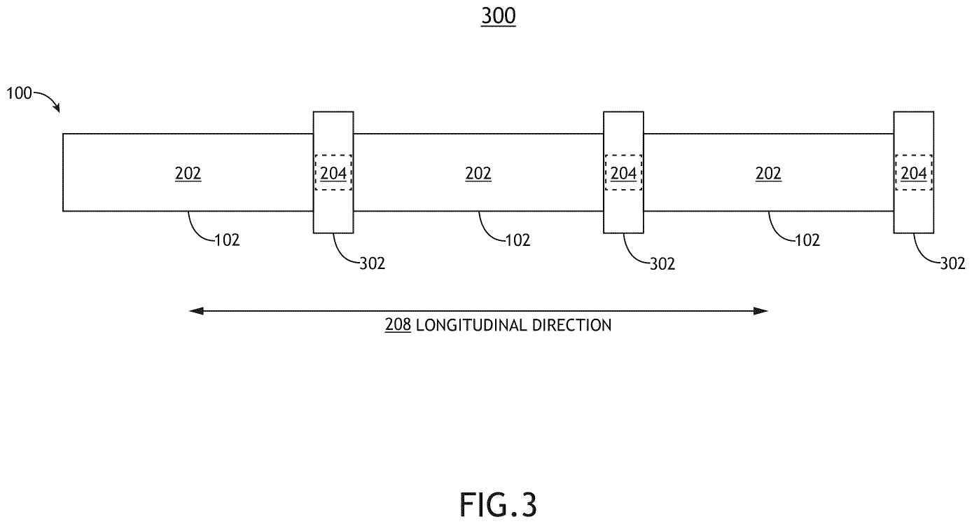

Additional embodiments of the present disclosure are directed to an optical cable including at least one HCF 100 with a low-index coating 102. FIG. 3 is a conceptual side view of an optical cable 300 including at least one HCF 100 with a low-index coating 102, in accordance with one or more embodiments of the present disclosure. An optical cable 300 may generally include one or more optical fibers of any type and may further include additional components to provide desired light-transmitting and/or mechanical properties. For example, an optical cable 300 may include a jacket surrounding the one or more optical fibers to provide mechanical strength, protection, and durability.

In some embodiments, an optical cable 300 including at least one HCF 100 with a low-index coating 102 and at least one cladding light stripping section 204 further includes one or more components to absorb or otherwise remove decoupled leakage light. For example, an optical cable 300 may include one or more beam dumps 302 at one or more cladding light stripping sections 204 of the HCF 100 to absorb the leakage light in a manner that does not result in damage. As an illustration, a beam dump 302 may include a heat sink to radiate heat from absorbed leakage light.

Additional embodiments of the present disclosure are directed to a hybrid optical fiber including one or more hollow core sections and one or more solid core sections, where the hybrid optical fiber further includes a low-index coating 102 at least partially covering both the hollow core sections and the solid core sections. For example, each of the hollow core sections may be formed as an HCF 100 and may include cladding light stripping sections, while each of the solid core sections may have solid cladding and core structures. In this configuration, the hollow core sections and the solid core sections may be spliced together.

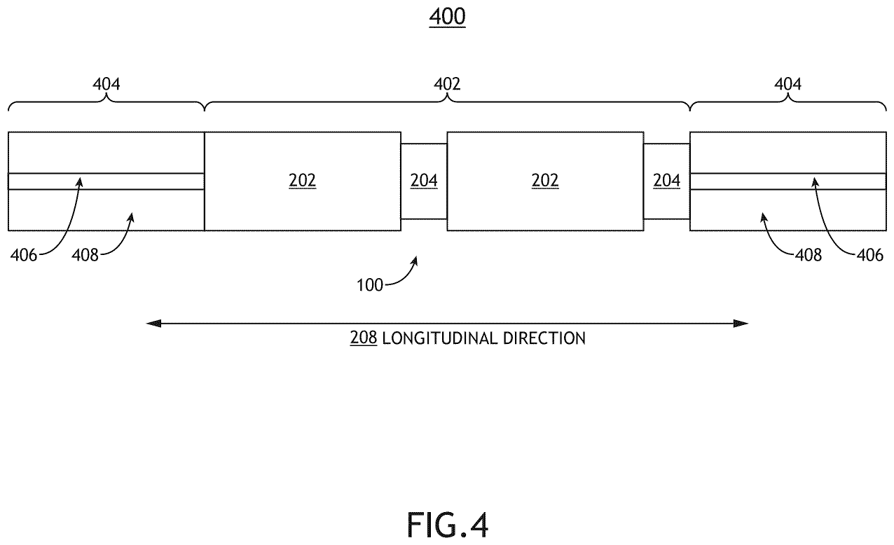

FIG. 4 is a simplified side view of a hybrid optical fiber 400 including hollow core sections 402 (e.g., sections of HCF 100) and solid core sections 404, in accordance with one or more embodiments of the present disclosure. In particular, FIG. 4 depicts a hybrid optical fiber 400 with a single hollow core section 402 (e.g., a single section of HCF 100) surrounded by two solid core sections 404. However, it is to be understood that a hybrid optical fiber 400 may include any number or arrangement of hollow core sections 402 and/or solid core sections 404.

In some embodiments, a hollow core section 402 is formed as an HCF 100 and may include any combination of cladding light guiding sections 202 and cladding light stripping sections 204 as disclosed herein. In some embodiments, a solid core section 404 is formed as a typical solid core optical fiber with a solid core 406 surrounded by a solid cladding 408. Further, any of the hollow core sections 402 and/or the solid core sections 404 may be designed to operate at single-mode fibers or multi-mode fibers for a particular wavelength.

In some embodiments, the hybrid optical fiber 400 includes a low-index coating 102 that is substantially uniform across the hollow core sections 402 and the solid core sections 404, except for any cladding light stripping sections 204 in any of the hollow core sections 402. In this way, leakage light may be guided in the cladding structure 104 of any of the hollow core sections 402 and the solid cladding 408 in any of the solid core sections 404.

It is contemplated herein that a hybrid optical fiber 400 including at least one hollow core section 402 and at least one solid core section 404 may be suitable for a wide variety of applications.

In some embodiments, a solid core section 404 may operate as a convenient splice point for the hybrid optical fiber 400. It is contemplated herein that it may generally be easier to cut and splice solid-core fibers than HCFs 100. It is further contemplated herein that optical fibers may be fabricated with custom selected fiber run lengths (e.g., lengths along the longitudinal direction 208) suitable for a particular application. Accordingly, in some embodiments, a hybrid optical fiber 400 includes solid core sections 404 on two ends and a hollow core section 402 in a middle portion. In this way, the two solid core sections 404 may provide convenient locations at which to cut and/or splice the hybrid optical fiber 400 during installation into a larger system or network. As an illustration, a hybrid optical fiber 400 may include at least one hollow core section with a selected fiber run length and at least one solid core section with a shorter fiber run length.

Further, this configuration may have the additional advantage of being compatible with commercial off-the-shelf couplers suitable for typical solid-core fibers, which many beneficially have lower cost than couplers suitable for HCFs 100. In some embodiments, a hybrid optical fiber 400 includes alternating solid core sections 404 and hollow core sections 402 providing additional flexibility to cut a spool of the hybrid optical fiber 400 to a desired length (e.g., lengths including any number of the hollow core sections 402).

In some embodiments, a hybrid optical fiber 400 may include at least one active solid core section 404. For example, an active solid core section 404 may have a solid core 406 that operates as an optical gain medium. As an illustration, the solid core 406 may be doped with one or more dopants suitable for establishing or maintaining a population inversion when pumped or otherwise excited. In this way, such an active solid core section 404 may operate as an optical amplifier and/or a laser source.

In some embodiments, such an active solid core 406 may form a portion of a fiber laser system that additionally includes pump sources and other components suitable for amplifying and/or generating laser light in the solid core section 404. Further, the generated laser light may then be directly coupled to a hollow core section 402 for delivery. In some embodiments, an active solid core 406 may operate as an optical amplifier (e.g., when pumped by an external pump beam) to amplify light propagating through the hybrid optical fiber 400.

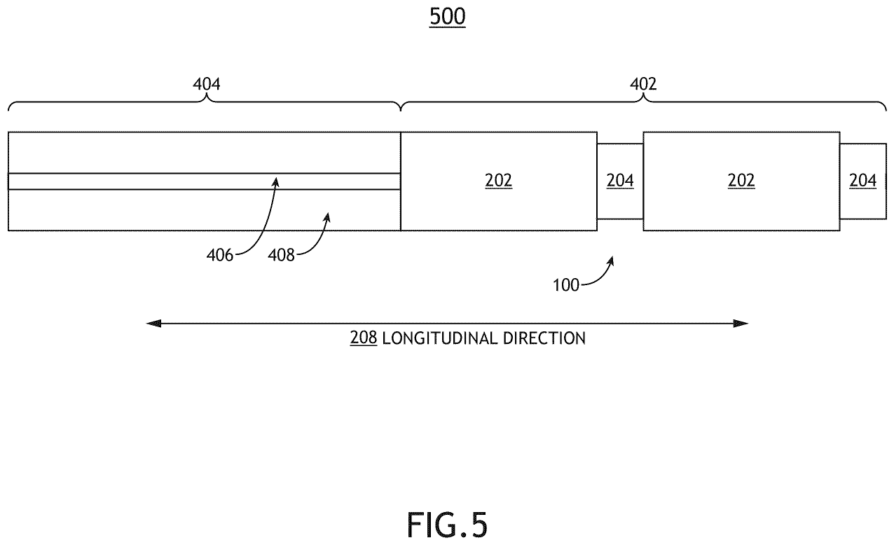

FIG. 5 is a simplified side view of an optical system 500 providing high power delivery of laser light, in accordance with one or more embodiments of the present disclosure.

In FIG. 5, the optical system 500 includes a hybrid optical fiber 400 including an active solid core section 404 to provide optical gain and a hollow core section 402 (e.g., a section of HCF 100) providing efficient delivery of light from the active solid core section 404. The optical system 500 may further include one or more pump sources (not shown) that provide pump light that induces a population inversion in the solid core 406 of the active solid core section 404 for the purpose of providing optical gain. The one or more pump sources may provide the pump light using any suitable pumping scheme such as, but not limited to, end pumping or side pumping.

In this configuration, the hollow core section 402 may deliver high-power laser light from the active solid core section 404. Further, the low-index coating 102 may provide that any leakage light is guided in the cladding structure 104 in the hollow core sections 402, where the leakage light may include light not initially coupled into the hollow central core 108 and/or light that decouples from the hollow central core 108 (e.g., due to bending or other factors). Further, the hollow core section 402 may have at least one cladding light guiding section 202 and any number (e.g., zero or more) cladding light stripping sections 204 to controllably decouple any leakage light from the cladding structure 104 at any location or locations.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A hollow core fiber (HCF) comprising:
a cladding structure extending in a longitudinal direction along a length of the HCF;
one or more antiresonant (AR) structures extending in the longitudinal direction along the length of the HCF and located in an interior region of the cladding structure, wherein the one or more AR structures form a hollow central core for guiding light; and
a low-index coating at least partially surrounding the cladding structure, wherein a refractive index of the low-index coating is lower than a refractive index of the cladding structure, wherein the refractive index the low-index coating is configured to provide guiding of leakage light, wherein the leakage light includes that decouples from the hollow central core.

2. The hollow core fiber of claim 1, wherein a thickness of the low-index coating is further configured to provide guiding of the leakage light.

3. The hollow core fiber of claim 2, wherein the thickness of the low-index coating is in a range of 5 micrometers to 100 micrometers.

4. The hollow core fiber of claim 1, wherein the hollow core fiber includes one or more cladding light guiding sections extending in the longitudinal direction and one or more cladding light stripping sections extending in the longitudinal direction, wherein the low-index coating in the one or more cladding light guiding sections has a first thickness, wherein the low-index coating in the one or more cladding light stripping sections has a second thickness smaller than the first thickness.

5. The hollow core fiber of claim 4, wherein at least one of the first thickness or lengths of the one or more cladding light stripping sections is selected to couple at least a portion of the leakage light out of the HCF.

6. The hollow core fiber of claim 4, wherein an outer surface of the cladding structure in the one or more cladding light stripping sections is roughened relative to an outer surface of the cladding structure in the one or more cladding light guiding sections.

7. The hollow core fiber of claim 1, wherein the refractive index of the low-index coating is in a range of 1.25 to 1.44.

8. The hollow core fiber of claim 1, wherein the low-index coating has a tensile modulus at 25° C. in a range of 40 MPa to 2000 MPa.

9. The hollow core fiber of claim 1, further comprising:
a high-modulus coating surrounding the low-index coating, wherein a tensile modulus of the high-modulus coating is higher than a tensile modulus of the low-index coating.

10. The hollow core fiber of claim 9, wherein a refractive index of the high-modulus coating is higher than the refractive index of the low-index coating.

11. The hollow core fiber of claim 1, wherein the leakage light further includes light coupled into the hollow core fiber that is not guided in the hollow central core.

12. The hollow core fiber of claim 1, wherein the cladding structure has a tubular shape.

13. An optical cable comprising:
a hollow core fiber (HCF) comprising:
a cladding structure extending in a longitudinal direction along a length of the HCF;
one or more antiresonant (AR) structures extending in the longitudinal direction along the length of the HCF and located in an interior region of the cladding structure, wherein the one or more AR structures form a hollow central core for guiding light; and
a low-index coating at least partially surrounding the cladding structure, wherein a refractive index of the low-index coating is lower than a refractive index of the cladding structure, wherein at least one of the refractive index or a thickness of the low-index coating is configured to provide guiding of leakage light, wherein the leakage light includes that decouples from the hollow central core;
wherein the HCF includes one or more cladding light guiding sections extending longitudinally along the HCF and one or more cladding light stripping sections extending in the longitudinal direction along the length of the HCF, wherein the low-index coating in the one or more cladding light guiding sections has a first thickness, wherein the low-index coating in the one or more cladding light stripping sections has
a second thickness smaller than the first thickness; and
one or more beam dumps in at least some of the one or more cladding light stripping sections to at least one of absorb the leakage light or direct the leakage light out of the optical cable.

14. The optical cable of claim 13, wherein at least one of the one or more beam dumps comprises:
a heat sink.

15. An optical fiber comprising:
one or more hollow core sections, each of the one or more hollow core sections formed as a hollow core fiber (HCF) comprising:
a cladding structure extending in a longitudinal direction along a length of the HCF; and
one or more antiresonant (AR) structures extending in the longitudinal direction along the length of the HCF and located in an interior region of the cladding structure, wherein the one or more AR structures form a hollow central core for guiding light;
one or more solid core sections, each of the one or more solid core sections formed as a solid core fiber comprising:
a solid core extending in the longitudinal direction; and
a solid cladding section surrounding the solid core; and
a low-index coating at least partially surrounding the one or more hollow core sections and the one or more solid core sections, wherein a refractive index of the low-index coating is lower than a refractive index of the cladding structure of each of the one or more hollow core sections and the solid core of each of the solid core sections.

16. The optical fiber of claim 15, wherein the one or more hollow core sections have a selected fiber run length, wherein the one or more solid core sections have lengths shorter than the selected fiber run length.

17. The optical fiber of claim 15, wherein the one or more solid core sections provide splice points for the optical fiber.

18. The optical fiber of claim 15, wherein at least one of the one or more solid core sections comprises:
an active fiber, wherein the solid core of the active fiber comprises an optical gain medium.
